(19) United States
(12) Patent Application Publication
(10) Pub. No.: US 2025/0276939 A1
(43) Pub. Date: Sep. 4, 2025

(54) LOW CONTENT PCBN GRADE WITH HIGH METAL CONTENT IN BINDER

(71) Applicant: Diamond Innovations, Inc., Worthington, OH (US)

(72) Inventors: Lawrence Dues, Dublin, OH (US); Rui Shao, Dublin, OH (US)

(73) Assignee: Diamond Innovations, Inc., Worthington, OH (US)

(21) Appl. No.: 18/859,229

(22) PCT Filed: May 16, 2023
(86) PCT No.: PCT/US2023/067045

§ 371 Date: Oct. 23, 2024

Related U.S. Application Data
(60) Provisional application No. 63/365,555, filed on May 31, 2022.

(51) Int. Cl. C04B 35/5831; C04B 35/626; C04B 35/645

(52) U.S. Cl. CPC C04B 35/5831; C04B 35/6261; C04B 35/6264; C04B 35/62655; C04B 35/645; B23B 2226/125; C04B 2235/3217; C04B 2235/3813; C04B 2235/3856; C04B 2235/386; C04B 2235/3865; C04B 2235/3886; C04B 2235/3895; C04B 2235/606; C04B 2235/656; C04B 2235/762; C04B 2235/785; C04B 2235/786

(57) ABSTRACT

Provided is a polycrystalline cubic boron nitride (PcBN) composition, which includes a cBN hard phase from about 60 vol. % to about 80 vol. % based on a total volume of the PcBN composition, and a ceramic binder phase from about 20 vol. % to about 40 vol. % based on a total volume of the PcBN composition. The ceramic binder phase includes an AlN phase, an Al₂O₃ phase, at least one Co(x)W(y)B(z) phase, and sub-stoichiometric (ss) titanium nitride (TiN), titanium carbonitride (TiCN), or a combination of TiN and TiCN. Associated methods of manufacturing sintered PcBN compacts, cutting tools, and compacts manufactured by using the PcBN composition are further presented.

### FIELD OF THE DISCLOSURE

The present disclosure relates to polycrystalline cubic boron nitride (PcBN) compositions with a high metal content ceramic binder. The present application further relates to associated methods of manufacturing sintered PcBN compacts, cutting tools and compacts that include the PcBN compositions.

### BACKGROUND

Cubic boron nitride (cBN) is a superabrasive hard material that is oftentimes associated with forming BN compacts for cutting and/or machining applications. Certain ceramic materials, such as alumina (Al₂O₃), titanium nitride (TiN), titanium carbide (TiC), titanium carbonitride (TiCN), silicon nitride (Si₃N₄), etc. may be blended with cBN, and further processed to improve the resistance of the cBN to physical wear and tear. However, such ceramic materials may not possess sufficient fracture toughness, hardness, and/or thermal resistance to perform optimally when machining hard materials. Moreover, existing PcBN-based compacts used to manufacture cutting tools may still exhibit rapid wear and tear, which is followed by fracture.

Increased fracture toughness is needed in hard part turning applications to prevent tools from fracturing, especially during interrupted cutting. Unreacted tungsten carbide (WC) particles generated during milling may act as propagation paths for cracks. Conventional PcBN compacts including one or more of sub-stoichiometric (ss) TiN, TiCN, AlN and Al₂O₃ typically have a sintered structure composed of cBN grains, a ceramic binder phase composed of TiN and TiCN grains, and Al₂O₃ embedded and anchored in the TiN and TiCN ceramic binder phase matrix. The Al₂O₃ may commonly be found as isolated small spots within the TiN and TiCN ceramic binder phase matrix, or may at times, even be found adjacent the cBN grains. In the microstructure, small white WC—Co islands, or particles can oftentimes also be seen. This is usually present as a byproduct of the milling bodies, which is referred to as mill debris in the metallurgy art. Fracture toughness can be increased by converting WC mill debris into tougher phases through chemical reactions with added Co. Nevertheless, a good ceramic binder phase is however instrumental to achieving a consistent operable performance, which typically involves aggressive milling of the ceramic binder to reach an optimal target size.

To manufacture PcBN materials used for toolmaking, the cBN powder may typically first be mixed with a ceramic binder substrate by forming a milling slurry composition of the mixed constituents with a milling liquid (e.g. water, solvents, alcohols, or any mixtures thereof). This is next followed by blending the constituents in for instance either typically a ball mill, an attritor mill, or a planetary mill generally for several hours to form a milling slurry blend.

The milling slurry blend may thereafter be subjected to for example vacuum drying, air drying, freeze drying, or spray drying, and the powder blend next undergoes a high-pressure-high-temperature (HPHT) sintering consolidation operation.

The core incentive of the milling operation is to facilitate a good ceramic binder distribution, and a good wettability between the cBN powder and the ceramic binder powder constituents. Importantly, tailoring the mixed constituents to the milling operation is fundamental and key to strengthening the physical integrity of the milled constituents.

A desirable ceramic binder distribution, and a good quality of wettability are essential parameters for obtaining PcBN-based tools that will not fracture when for instance cutting or machining ferrous metals. On the downside, a non-trivial outcome is that, if the ceramic binder distribution and wettability are of a rather poor standard and quality, pores and cracks may undesirably emerge as a result of the susceptibility in the final sintered PcBN body, which is detrimental to the manufactured PcBN compact.

In view of the foregoing, there is therefore a need for PcBN compositions with strengthened physical properties for manufacturing robust high-quality tools with stellar performance for cutting and machining difficult-to-cut materials.

### SUMMARY

Provided is a polycrystalline cubic boron nitride (PcBN) composition. The PcBN composition includes a cBN hard phase from about 60 vol. % to about 80 vol. % based on a total volume of the PcBN composition. Additionally, the composition has a ceramic binder phase from about 20 vol. % to about 40 vol. % based on a total volume of the PcBN composition. The ceramic binder phase includes an AlN phase, an Al₂O₃ phase, and at least one tough Co(x)W(y)B(z) phase.

Optionally, the ceramic binder phase includes sub-stoichiometric (ss) titanium nitride (TiN), titanium carbonitride (TiCN), or a combination thereof.

Optionally, the ceramic binder phase includes substoichiometric or stoichiometric TiNO, TiCNO, or a combination thereof.

Optionally, cBN grains have a grain size in a range of from about 3 microns to about 6 microns.

Optionally, the cBN grains have a grain size in a range of from about 2 microns to about 4 microns.

Optionally, Co grains have a grain size in a range of from about 0.1 micron to about 1 micron.

Optionally, tungsten carbide (WC) grains have a grain size in a range of from about 0.1 micron to about 1 micron.

Optionally, (x) is 1, (y) is 2 and (z) is 2, and the at least one Co(x)W(y)B(z) tough phase includes CoW₂B₂.

Optionally, (x) is 1, (y) is 1 and (z) is 1, and the at least one Co(x)W(y)B(z) tough phase comprises CoWB.

Optionally, an amount of aluminum ranges from about 3 wt. % to about 6 wt. %, an amount of cobalt ranges from about 0.9 wt. % to about 2.5 wt. %, and an amount of tungsten ranges from about 5 wt. % to about 8 wt. % based on a total weight of the PcBN composition.

Further provided is a method of manufacturing a sintered polycrystalline cubic boron nitride (PcBN) compact, which includes milling a powder mixture including powders forming hard constituents of (i) a cBN hard phase from about 60 vol. % to about 80 vol. % based on a total volume of the powder mixture and (ii) a ceramic binder phase from about 20 vol. % to about 40 vol. % based on a total volume of the powder mixture, with milling bodies including therein at least tungsten carbide (WC) to form a powder blend and generate mill debris. Next, the formed powder blend is dried. Finally, the constituents of the powder blend are reacted at high-pressure-high-temperature (HPHT) conditions to form an AlN phase, an Al₂O₃ phase, and at least one tough Co(x)W(y)B(z) phase in the ceramic binder phase.

Optionally, the drying the powder blend includes vacuum drying, air drying, freeze drying, or spray drying.

Optionally, the milling is done with one or more solvents including ethanol, methanol, isopropanol, butanol, cyclohexanol, acetone, hexane, heptane, toluene, water, or any combination thereof as a milling slurry of the powder blend.

Optionally, the HPHT conditions include pressures in a range of from about 4 gigapascal (GPa) to about 8 GPa and temperatures in a range of from about 1100° C. to about 1800° C.

Optionally, the powder blend is loaded into refractory metal cups after drying the powder blend.

Further provided are cutting tools incorporating the PcBN composition.

Additionally provided are compacts incorporating the PcBN composition.

Other systems, methods, features and advantages will be, or will become apparent to one with skill in the art upon examination of the following figures and detailed description. It is intended that all such additional systems, methods, features and advantages be included within this description, be within the scope of the present disclosure, and be protected by the following claims. Nothing in this section should be taken as a limitation on those claims. Further aspects and advantages are discussed below in conjunction with the embodiments of the disclosure. It is to be understood that both the foregoing general description and the following detailed description of the present disclosure are examples and explanatory and are intended to provide further explanation of the disclosure as claimed.

### BRIEF DESCRIPTION OF THE DRAWINGS

The accompanying drawings, which are included to provide a further understanding of the subject matter and are incorporated in and constitute a part of this specification, illustrate implementations of the subject matter and together with the description serve to explain the principles of the disclosure.

FIG. 1A shows an exemplary geometry of a sintered unsupported polycrystalline cubic boron nitride (PcBN)-based compact that incorporates cBN particles in accordance with an exemplary embodiment of the subject matter.

FIG. 1B shows an exemplary geometry of a sintered supported polycrystalline cubic boron nitride (PcBN)-based compact that incorporates cBN particles in accordance with an exemplary embodiment of the subject matter.

FIG. 2 is a flow diagram showing the individual process steps of manufacturing a sintered polycrystalline cubic boron nitride (PcBN)-based compact for use in a cutting tool in accordance with an exemplary embodiment of the subject matter.

FIG. 3 shows an X-ray diffraction (XRD) spectrum showing phases present in an exemplary polycrystalline cubic boron nitride (PcBN)-based sintered compact with a titanium nitride (TiN) ceramic binder.

FIG. 4 shows an X-ray diffraction (XRD) spectrum showing phases present in an exemplary polycrystalline cubic boron nitride (PcBN)-based sintered compact with a sub-stoichiometric (ss) titanium carbonitride (TiCN) ceramic binder.

FIG. 5A is a scanning electron microscope (SEM) image of a microstructure of an exemplary polycrystalline cubic boron nitride (PcBN)-based sintered compact with a titanium nitride (TiN) ceramic binder shown at a 2000× magnification.

FIG. 5B is a scanning electron microscope (SEM) image of a microstructure of an exemplary polycrystalline cubic boron nitride (PcBN)-based sintered compact with a titanium nitride (TiN) ceramic binder shown at a 10000× magnification.

FIG. 6A is a scanning electron microscope (SEM) image of a microstructure of an exemplary polycrystalline cubic boron nitride (PcBN)-based sintered compact with a sub-stoichiometric (ss) titanium carbonitride (TiCN) ceramic binder shown at a 2000× magnification.

FIG. 6B is a scanning electron microscope (SEM) image of a microstructure of an exemplary polycrystalline cubic boron nitride (PcBN)-based sintered compact with a sub-stoichiometric (ss) titanium carbonitride (TiCN) ceramic binder shown at a 10000× magnification.

FIG. 7A shows an X-ray diffraction (XRD) spectrum showing phases present in Formulation A (65 vol. cBN, 22 vol. %-23 vol. % TiN, 5 wt. % aluminum, 0.15 wt. % cobalt, 2.6 wt. % tungsten) of an exemplary polycrystalline cubic boron nitride (PcBN)-based sintered compact with a titanium nitride (TiN) ceramic binder.

FIG. 7B shows an X-ray diffraction (XRD) spectrum showing phases present in Formulation B (65 vol. cBN, 21 vol. %-22 vol. % TiN, 5 wt. % aluminum, 1.4 wt. % cobalt, 6.4 wt. % tungsten) of an exemplary polycrystalline cubic boron nitride (PcBN)-based sintered compact with a titanium nitride (TiN) ceramic binder.

FIG. 7C shows an X-ray diffraction (XRD) spectrum showing phases present in Formulation C (70 vol. cBN, 22 vol. %-23 vol. % TiN, 3.8 wt. % aluminum, 0.2 wt. % cobalt, 2.6 wt. % tungsten) of an exemplary polycrystalline cubic boron nitride (PcBN)-based sintered compact with a titanium nitride (TiN) ceramic binder.

FIG. 7D shows an X-ray diffraction (XRD) spectrum showing phases present in Formulation D (72 vol. cBN, 21 vol. %-22 vol. % TiN, 4.1 wt. % aluminum, 1.1 wt. % cobalt, 5.2 wt. % tungsten) of an exemplary polycrystalline cubic boron nitride (PcBN)-based sintered compact with a titanium nitride (TiN) ceramic binder.

FIG. 7E shows an X-ray diffraction (XRD) spectrum showing phases present in Formulation E (62 vol. cBN, 22 vol. %-23 vol. % TiCN, 4.4 wt. % aluminum, 0.2 wt. % cobalt, 2.7 wt. % tungsten) of an exemplary polycrystalline cubic boron nitride (PcBN)-based sintered compact with a sub-stoichiometric (ss) titanium carbonitride (TiCN) ceramic binder.

FIG. 7F shows an X-ray diffraction (XRD) spectrum showing phases present in Formulation F (70 vol. cBN, 21 vol. %-22 vol. % TiCN, 3.3 wt. % aluminum, 1.1 wt. % cobalt, 5.1 wt. % tungsten) of an exemplary polycrystalline cubic boron nitride (PcBN)-based sintered compact with a sub-stoichiometric (ss) titanium carbonitride (TiCN) ceramic binder.

### DETAILED DESCRIPTION

Unless defined otherwise all technical and scientific terms used herein have the same meaning as commonly understood to one of ordinary skill in the art to which the presently described subject matter pertains.

Where a range of values is provided, for example, concentration ranges, percentage ranges, or ratio ranges, it is understood that each intervening value, to the tenth of the unit of the lower limit, unless the context clearly dictates otherwise, between the upper and lower limit of that range and any other stated or intervening value in that stated range, is encompassed within the described subject matter. The upper and lower limits of these smaller ranges may independently be included in the smaller ranges, and such embodiments are also encompassed within the described subject matter, subject to any specifically excluded limit in the stated range. Where the stated range includes one or both of the limits, ranges excluding either or both of those included limits are also included in the described subject matter.

The following definitions set forth the parameters of the described subject matter.

As used herein this disclosure, the term “mill debris” generally refers to at least WC material formed from a milling media, or the linings of a mill, due to the friction between cBN abrasive particles, milling bodies, and milling linings. There are many factors that determine the amount of mill debris that can be generated including for example at least the milling media volume and density, jar size, and the milling slurry viscosity. Mill debris normally increases proportionally with milling time, cBN particle size, and milling speed. Since cBN particles are considerably harder and more rigid than cemented WC particles, when cBN particles are present in the mill, significant mill debris can therefore naturally be generated. Since the WC particles are being added to a blend for further processing by scratching, scraping, or wearing away WC particles off of a cemented WC milling media, one way to determine the particle size of WC obtained from mill debris is by employing scanning electron microscopy (SEM) images. This is practically performed by measuring, what is referred to as the Feret diameter. One of ordinary skill in the art would know that to determine the Feret diameter, first a rectangle is drawn that completely encloses a WC particle. The length of the long side of the rectangle is the maximum Feret diameter. The length of the short side of the rectangle is the minimum Feret diameter. Thus, from multiple SEM images, an average maximum Feret diameter, and an average minimum Feret diameter of the WC particle obtained from mill debris can be calculated, to ultimately determine the WC particle size obtained from the mill debris.

As used herein this disclosure, the term “PcBN compact” refers to a sintered product composed of an accumulated mass of a plurality of wear-resistant superabrasive cBN particles compacted and bonded together in either a self-bonded relationship, by way of a bonding medium, or by means of a combination thereof. As used herein this disclosure, the term “PcBN composite compact” refers to a PcBN compact, which is supported on a cemented WC substrate.

As used herein this disclosure, the term “particle” refers to a discrete body or discrete bodies. As used herein this disclosure, the term “particle” is also considered a crystal or a grain.

As used herein this disclosure, the term “vol. %” or “wt. %” refers to a given volume percent or weight percent based on (I) a total volume, or a total weight of a PcBN composition, (II) a total volume of a powder mixture, or (III) a total weight of a PcBN compact, unless specifically indicated otherwise. When “vol. %” or “wt. %” is mentioned in the disclosure or in the appended claims, it will also explicitly be mentioned, whether it refers to a given vol. percent of (I), (II), or (III) in each given specific scenario.

Grades can be classified for example according to the grain size. Different types of grades for different types of materials have been defined as nano, ultrafine, submicron, fine, medium, medium coarse, coarse and extra coarse. As used herein this disclosure, the term (I) “nano grade” is defined as a component of the CBN composition with a grain size of less than about 0.2 micron, (II) “ultrafine grade” is defined as a component of the CBN composition with a grain size from about 0.2 micron to about 0.5 micron, (III) “submicron grade” is defined as a component of the CBN composition with a grain size from about 0.5 micron to about 0.9 micron, (IV) “fine grade” is defined as a component of the CBN composition with a grain size from about 1.0 micron to about 1.3 microns, (V) “medium grade” is defined as a component of the CBN composition with a grain size from about 1.4 microns to about 2.0 microns, (VI) “medium coarse grade” is defined as a component of the CBN composition with a grain size from about 2.1 microns and to about 3.4 microns, (VII) “coarse grade” is defined as a component of the CBN composition with a grain size from about 3.5 microns to about 5.0 microns, and (VIII) “extra coarse grade” is defined as a component of the CBN composition with a grain size greater than about 5.0 microns.

As used herein this disclosure, the term “superabrasive ultrahard material”, or simply “superabrasive material” refers to an abrasive material demonstrating superior hardness and abrasion resistance, which may exhibit Knoop indentation hardness surpassing 2000, as found in the following, but not limited to crystal diamond, polycrystalline diamond (PCD), thermally stable polycrystalline diamond, chemical vapor deposition (CVD) diamond, metal matrix diamond composites, ceramic matrix diamond composites, nanodiamond, cubic boron nitride (cBN), polycrystalline cubic boron nitride (PcBN), or any such combinations thereof. The term “abrasive”, as used herein, refers to any material used to wear away softer material.

As used herein this disclosure, the term “about” is meant to mean plus or minus 5% of the numerical value of the number with which it is being used in the claims and herein this disclosure. Thus, “about” may be used to provide flexibility to a numerical range endpoint, in which, a given value may be “above” or “below” the given value. As such, for example a value of 50% may be intended to encompass a range, which may be defined by for example ranges like 47.5%-52.25%, 47.5%-52.5%, 47.75%-50%, 50%-52.5%, 48%-48.5%, 48%-48.75%, 48%-49%, 48%-49.5%, 48%-49.75%, 48%-50%, 48%-50.25%, 48%-50.5%, 48%-50.75%, 48%-51%, 48%-51.5%, 48%-51.75%, 48%-52%, 48%-52.25%, 48%-52.5%, 48.25%-48.5%, 48.25%-48.75%, 48.25%-49%, 48.25%-49.5%, 48.25%-49.75%, 48.25%-50%, 48.25%-50.25%, 48.25%-50.5%, 48.25%-50.75%, 48.25%-51%, 48.25%-51.25%, 48.25%-51.5%, 48.25%-51.75%, 48.25%-52%, 48.25%-52.25%, 48.25%-52.5%, 48.5%-48.75%, 48.5%-49%, 48.5%-49.5%, 48.5%-49.75%, 48.5%-50%, 48.5%-50.25%, 48.5%-50.5%, 48.5%-50.75%, 48.5%-51%, 48.5%-51.25%, 48.5%-51.5%, 48.5%-51.75%, 48.5%-52%, 48.5%-52.25%, 48.5%-52.5%, 49%-49.25%, 49%-49.5%, 49%-49.75%, 49%-50%, 49%-50.25%, 49%-50.5%, 49%-50.75%, 49%-51%, 49%-51.25%, 49%-51.5%, 49%-51.75%, 49%-52%, 49%-52.25%, 49%-52.5% 49.5%-49.75%, 49.5%-50%, 49.5%-50.25%, 49.5%-50.5%, 49.5%-50.75%, 49.5%-51%, 49.5%-51.5%, 49.5%-51.75%, 49.5%-52%, 49.5%-52.25%, 49.5%-52.5%, 49.75%-50%, 49.75%-50.25%, 49.75%-50.5%, 49.75%-50.75%, 49.75%-51%, 49.75%-51.25%, 49.75%-51.5%, 49.75%-51.75%, 49.75%-52%, 49.75%-52.25%, 49.75%-52.5%, 50%-50.25%, 50%-50.5%, 50%-50.75%, 50%-51%, 50%-51.25%, 50%-51.5%, 50%-52%, 50%-52.25%, 50%-52.5% etc.

Wherever used throughout the disclosure, the term “generally” has the meaning of “typically” or “closely” or “within the vicinity or range of”.

As used herein, the term “substantially” refers to the complete or nearly complete extent or degree of an action, characteristic, property, state, structure, item, or result.

As used herein, “spherical” refers to the grains having a substantially “round” shape.

As used herein this disclosure, the term “fracture toughness” refers to the ability of a material to resist fracture, and/or crack propagation.

As used herein this disclosure, the term “high pressure high temperature (HPHT) sintering” refers to a process, where heating under pressure typically ranging from about 4 gigapascal (GPa) to about 8 GPa, is conducted to minimize the surface of a cBN-based particulate system, which is associated with generation of bonds between neighboring small cBN particles or cBN granules, and shrinkage of the subsequently aggregated cBN particles or cBN granules. Compacting and forming a dense bulk mass is performed by heating the small cBN particles under pressure. The atoms in the small cBN particles diffuse across the boundaries of the cBN particles, thus fusing the small cBN particles together, thereby creating one solid dense bulk piece.

### Polycrystalline Cubic Boron Nitride (PcBN) Compositions

The current disclosure is based on the premise of presenting polycrystalline cubic boron nitride (PcBN) compositions, where the cBN hard phase is reacted with high levels of metallic content of aluminum (Al), cobalt (Co), and tungsten (W) being present within a ceramic binder phase. The ceramic binder is constituted of sub-stoichiometric (ss) titanium nitride (TiN), titanium carbonitride (TiCN), or a combination thereof, i.e. the ratio N/Ti or CN/Ti being substantially lower than 1. The ceramic binder in the PcBN composition exhibits an increased fracture toughness afforded by the reaction of Co in the ceramic binder with the added mill debris having at least therein tungsten carbide (WC) particles. Without wishing to be bound by theory, it has been hypothesized that unreacted WC particles that are generated during milling (i.e. mill debris) act as propagation paths for cracks. The reader will realize that the advantages over simply adding a WC-containing powder are at least manifold. As a first matter, mill debris is uniformly dispersed throughout a blend that the mill debris is added into. Secondly, mill debris is very fine, typically less than about 1 micron. Indeed, sourcing, safely handling, and dispersing submicron powders is a rather challenging task in this matter, and the current subject matter thus avoids such challenges. During high-pressure-high-temperature (HPHT) sintering, the Co in the ceramic binder reacts with the WC particles obtained from the mill debris as described in paragraph ¶ [0046], and the boron in the cBN, thereby forming at least one discrete tough Co(x)W(y)B(z) phase within the ceramic binder, where the cobalt no longer acts as a binder, but instead, acts as a hard phase. In other words, the cobalt in the at least one tough Co(x)W(y)B(z) phase is no longer metallic. In one example, (x) is 1, (y) is 2 and (z) is 2, and the at least one Co(x)W(y)B(z) tough phase includes CoW₂B₂. In another example, (x) is 1, (y) is 1 and (z) is 1, and the at least one Co(x)W(y)B(z) tough phase includes CoWB. Further formed individual phases within the ceramic binder are at least an AlN phase and an Al₂O₃ phase. The milling bodies are composed of 94 wt. % WC with 6 wt. % Co binder. The mill debris has the same composition as the milling bodies, i.e. 94 wt. % WC and 6 wt. % Co. However, in general a cobalt content of 6 wt. % is not enough to form the aforementioned tough CoW₂B₂ phase. Thus, additional metallic cobalt is typically added to the milling slurry. The carbon removed from the WC is instead integrated into the TiN/TiCN matrices of the ceramic binder.

The cBN hard phase may typically be present from about 60 vol. % to about 80 vol. % based on the total volume of the PcBN composition. In some examples, the cBN hard phase is present from about 62 vol. % to about 80 vol. % vol. % based on the total volume of the PcBN composition. In other examples, the cBN hard phase is present from about 65 vol. % to about 80 vol. % based on the total volume of the PcBN composition. In yet other examples, the cBN hard phase is present from about 67 vol. % to about 80 vol. % based on the total volume of the PcBN composition. In still other examples, the cBN hard phase is present from about 69 vol. % to about 80 vol. % vol. % based on the total volume of the PcBN composition. In even other examples, the cBN hard phase is present from about 71 vol. % to about 80 vol. % based on the total volume of the PcBN composition. In further other examples, the cBN hard phase is present from about 73 vol. % to about 80 vol. % based on the total volume of the PcBN composition. In other embodiments, the cBN hard phase is present from about 75 vol. % to about 80 vol. % based on the total volume of the PcBN composition. In still other embodiments, the cBN hard phase is present from about 77 vol. % to about 80 vol. % vol. % based on the total volume of the PcBN composition. In even other embodiments, the cBN hard phase is present from about 78 vol. % to about 80 vol. % based on the total volume of the PcBN composition.

The cBN hard phase may also be present from about 60 vol. % to about 62 vol. %, 60 vol. % to about 65 vol. %, from about 62 vol. % to about 65 vol. %, from about 65 vol. % to about 67 vol. %, from about 60 vol. % to about 67 wt. %, from about 60 vol. % to about 70 wt. %, from about 60 vol. % to about 72 wt. %, from about 60 vol. % to about 75 wt. %, from about 67 vol. % to about 69 vol. %, from about 69 vol. % to about 71 vol. %, from about 71 vol. % to about 73 vol. %, from about 67 vol. % to about 73 vol. %, from about 67 vol. % to about 75 vol. %, from about 67 vol. % to about 77 vol. %, from about 70 vol. % to about 75 vol. %, from about 70 vol. % to about 77 vol. %, from about 70 vol. % to about 79 vol. %, from about 73 vol. % to about 75 vol. %, from about 73 vol. % to about 77 vol. %, or from about 75 vol. % to about 77 vol. % based on the total volume of the PcBN composition.

The ceramic binder described herein this disclosure may generally be composed of carbides, borides, nitrides, carbonitrides, or oxides of at least one metal selected from groups 4, 5 and 6 of the periodic table, or any combinations thereof.

In a particular embodiment, the ceramic binder is composed of sub-stoichiometric (ss) TiN, TiCN, or a combination thereof. Without wishing to be bound by any particular theory, it is believed that Ti-containing binders (e.g., TiN, TiCN) can function as ceramic binders, and generally have similar effects on improving the cutting capabilities of a tool formed by the compact. In still other embodiments, the ceramic binder is composed of substoichiometric or stoichiometric TiNO, TiCNO, or a combination thereof.

The ceramic binder and grain growth inhibitors during sintering like vanadium carbide (VC), chromium carbide (Cr₃C₂), tantalum carbide (TaC), titanium carbide (TiC), zirconium carbide (ZrC), niobium carbide (NbC), may be present in the PcBN composition in any possible combination that is not inconsistent and incompatible with the objectives of the present subject matter.

The ceramic binder phase may typically be present from about 20 vol. % to about 40 vol. % based on the total volume of the PcBN composition. In some examples, the ceramic binder phase is present from about 22 vol. % to about 40 vol. % based on the total volume of the PcBN composition. In other examples, the ceramic binder phase is present from about 24 vol. % to about 40 vol. % based on the total volume of the PcBN composition. In yet other examples, the ceramic binder phase is present from about 26 vol. % to about 40 vol. % based on the total volume of the PcBN composition. In still other examples, the ceramic binder phase is present from about 28 vol. % to about 40 vol. % based on the total volume of the PcBN composition. In further other examples, the ceramic binder phase is present from about 30 vol. % to about 40 vol. % based on the total volume of the PcBN composition. In even other examples, the ceramic binder phase is present from about 32 vol. % to about 40 vol. % based on the total volume of the PcBN composition. In other embodiments, the ceramic binder phase is present from about 34 vol. % to about 40 vol. % based on the total volume of the PcBN composition. In still other embodiments, the ceramic binder phase is present from about 36 vol. % to about 40 vol. % based on the total volume of the PcBN composition. In yet other embodiments, the ceramic binder phase is present from about 38 vol. % to about 40 vol. % based on the total volume of the PcBN composition.

The ceramic binder phase may also be present from about 20 vol. % to about 22 vol. %, from about 22 vol. % to about 24 vol. %, from about 24 vol. % to about 26 vol. %, from about 26 vol. % to about 28 vol. %, from about 20 vol. % to about 25 vol. %, from about 20 vol. % to about 26 vol. %, from about 20 vol. % to about 27 vol. %, from about 20 vol. % to about 28 vol. %, from about 20 vol. % to about 29 vol. %, from about 20 vol. % to about 30 vol. %, from about 25 vol. % to about 30 vol. %, 26 vol. % to about 30 vol. %, from about 27 vol. % to about 30 vol. %, from about 28 vol. % to about 30 vol. %, from about 29 vol. % to about 30 vol. %, from about 30 vol. % to about 32 vol. %, from about 30 vol. % to about 35 vol. %, from about 30 vol. % to about 37 vol. %, from about 32 vol. % to about 34 vol. %, from about 32 vol. % to about 35 vol. %, from about 34 vol. % to about 36 vol. %, from about 36 vol. % to about 38 vol. %, from about 35 vol. % to about 40 vol. %, or from about 38 vol. % to about 40 vol. % based on the total volume of the PcBN composition.

Grain growth inhibitors may typically be present from about 1 vol. % to about 2 vol. % 1 vol. % to about 3 vol. %, from about 2 vol. % to about 5 vol. %, from about 5 vol. % to about 7 vol. %, from about 3 vol. % to about 7 vol. %, from about 7 vol. % to about 10 vol. %, about 10.1 vol. %, about 10.2 vol. %, about 10.3 vol. %, about 10.4 vol. %, about 10.5 vol. %, about 10.6 vol. %, about 10.7 vol. %, about 10.8 vol. %, about 10.9 vol. %, from about 7 vol. % to about 20 vol. %, from about 10 vol. % to about 20 vol. %, from about 12 vol. % to about 20 vol. %, from about 15 vol. % to about 20 vol. %, from about 17 vol. % to about 20 vol. %, from about 10 vol. % to about 12 vol. %, from about 10 vol. % to about 15 vol. %, from about 10 vol. % to about 17 vol. %, from about 10 vol. % to 20 about vol. %, from about 15 vol. % to about 20 vol. %, or from about 17 vol. % to about 20 vol. % based on the total volume of the PcBN composition.

The cBN grains may typically have a grain size ranging from about 2 microns to about 4 microns, or a grain size spanning from about 3 microns to about 6 microns. In some examples, the cBN grains have a grain size from about 2.5 microns to about 4 microns. In other examples, the cBN grains have a grain size from about 3 microns to about 4 microns. In still other examples, the cBN grains have a grain size from about 3.5 microns to about 4 microns. In yet other examples, the cBN grains have a grain size from about 3.5 microns to about 6 microns. In further other examples, the cBN grains have a grain size from about 4 microns to about 6 microns. In even other examples, the cBN grains have a grain size from about 4.5 microns to about 6 microns. In even further other examples, the cBN grains have a grain size from about 5 microns to about 6 microns. In other embodiments, the cBN grains have a grain size from about 5.5 microns to about 6 microns.

The cBN grains may also have a grain size from about 2 microns to about 2.25 microns, from about 2 microns to about 2.5 microns, from about 2 microns to about 2.75 microns, from about 2 microns to about 3 microns, from about 2 microns to about 3.25 microns, from about 2 microns to about 3.5 microns, from about 2 microns to about 3.75 microns, from about 2.5 microns to about 2.75 microns, from about 2.5 microns to about 3 microns, from about 2.5 microns to about 3.25 microns, from about 2.5 microns to about 3.5 microns, from about 2.5 microns to about 3.75 microns, from about 2.25 microns to about 2.5 microns, from about 2.25 microns to about 2.75 microns, from about 2.25 microns to about 3 microns, from about 2.25 microns to about 3.25 microns, from about 2.25 microns to about 3.5 microns, from about 2.25 microns to about 3.75 microns, from about 2.25 microns to about 4 microns, from about 2.5 microns to about 3.25 microns, from about 2.75 microns to about 3.25 microns, from about 2.75 microns to about 3.5 microns, from about 3 microns to about 3.25 microns, from about 3 microns to about 3.5 microns, from about 2.75 microns to about 3.75 microns, from about 3 microns to about 3.5 microns, from about 3 microns to about 3.75 microns, from about 2.5 microns to about 4 microns, from about 2.75 microns to about 4 microns, from about 3.25 microns to about 4 microns, from about 3.5 microns to about 4 microns, from about 3.75 microns to about 4 microns, from about 3 microns to about 4.25 microns, from about 3 microns to about 4.5 microns, from about 3 microns to about 4.75 microns, from about 3 microns to about 5 microns, from about 3 microns to about 5.25 microns, from about 3 microns to about 5.5 microns, from about 3 microns to about 5.75 microns, from about 4 microns to about 4.25 microns, from about 4 microns to about 4.5 microns, from about 4 microns to about 4.75 microns, from about 4 microns to about 5 microns, from about 4 microns to about 5.25 microns, from about 4 microns to about 5.5 microns, from about 4 microns to about 5.75 microns, from about 4.5 microns to about 4.75 microns, from about 4.5 microns to about 5 microns, from about 4.5 microns to about 5.25 microns, from about 4.5 microns to about 5.5 microns, from about 4.5 microns to about 5.75 microns, from about 4.5 microns to about 6 microns, from about 4.75 microns to about 5 microns, from about 4.75 microns to about 5.25 microns, from about 4.75 microns to about 5.5 microns, from about 4.75 microns to about 5.75 microns, from about 4.75 microns to about 6 microns, from about 5 microns to about 5.25 microns, from about 5.25 microns to about 5.5 microns, from about 5 microns to about 5.5 microns, or from about 5 microns to about 5.75 microns.

The WC grains in the mill debris may typically have a grain size ranging from about 0.1 micron to about 1 micron. In certain particular embodiments, the WC grains have a grain size from about 0.1 micron to about 0.2 micron, from about 0.2 micron to about 0.3 micron, from about 0.3 micron to about 0.4 micron, from about 0.1 micron to about 0.4 micron, 0.1 micron to about 0.5 micron, 0.2 micron to about 0.5 micron, 0.3 micron to about 0.5 micron, from about 0.4 micron to about 0.5 micron, from about 0.5 micron to about 0.6 micron, from about 0.5 micron to about 0.7 micron, from about 0.5 micron to about 0.8 micron, from about 0.5 micron to about 0.9 micron, from about 0.5 micron to about 1.0 micron, from about 0.6 micron to about 0.7 micron, from about 0.4 micron to about 0.7 micron, from about 0.4 micron to about 0.8 micron, from about 0.4 micron to about 0.9, from about 0.4 micron to about 1.0 micron, from about 0.7 micron to about 0.8 micron, from about 0.8 micron to about 0.9 micron, from about 0.1 micron to about 1.0 micron, from about 0.2 micron to about 1.0 micron, from about 0.3 micron to about 1.0 micron, from about 0.4 micron to about 1.0 micron, from about 0.6 micron to about 1.0 micron, from about 0.7 micron to about 1.0 micron, from about 0.8 micron to about 1.0 micron, or from about 0.9 micron to about 1.0 micron.

The Co grains may typically have a grain size ranging from about 0.1 micron to about 1 micron. In certain particular embodiments, the Co grains have a grain size from about 0.1 micron to about 0.2 micron, from about 0.2 micron to about 0.3 micron, from about 0.3 micron to about 0.4 micron, from about 0.1 micron to about 0.4 micron, from about 0.1 micron to about 0.5 micron, from about 0.2 micron to about 0.5 micron, from about 0.3 micron to about 0.5 micron, from about 0.4 micron to about 0.5 micron, from about 0.5 micron to about 0.6 micron, from about 0.5 micron to about 0.7 micron, from about 0.5 micron to about 0.8 micron, from about 0.5 micron to about 0.9 micron, from about 0.5 micron to about 1.0 micron, from about 0.6 micron to about 0.7 micron, from about 0.4 micron to about 0.7 micron, from about 0.4 micron to about 0.8 micron, from about 0.4 micron to about 0.9, from about 0.4 micron to about 1.0 micron, from about 0.7 micron to about 0.8 micron, from about 0.8 micron to about 0.9 micron, from about 0.1 micron to about 1.0 micron, from about 0.2 micron to about 1.0 micron, from about 0.3 micron to about 1.0 micron, from about 0.4 micron to about 1.0 micron, from about 0.6 micron to about 1.0 micron, from about 0.7 micron to about 1.0 micron, from about 0.8 micron to about 1.0 micron, or from about 0.9 micron to about 1.0 micron.

For determining a specific cBN grain size or a particular Co grain size, one having ordinary skill in the art may typically employ either dynamic digital image analysis (DIA), static laser light scattering (SLS) also known as laser diffraction, or visual measurement by electron microscopy, a technique known as image analysis and light obscuration. Each method covers a characteristic size range within which measurement is possible. These ranges partly overlap. However, the results for measuring the same sample may vary all depending on the particular method that is used. A skilled artisan who wants to determine grain sizes, or particle size distributions would readily know how each mentioned method is commonly performed and practiced. Thus, the reader is directed to for example, (i) “Comparison of Methods. Dynamic Digital Image Analysis, Laser Diffraction, Sieve Analysis”, Retsch Technology and (ii) the scientific publication by Kelly et al., “Graphical comparison of image analysis and laser diffraction particle size analysis data obtained from the measurements of nonspherical particle systems”, AAPS PharmSciTech. 2006 Aug. 18; Vol. 7(3):69, to further gain insight into each procedure and methodology, all of which documents, are incorporated herein by reference in their entirety.

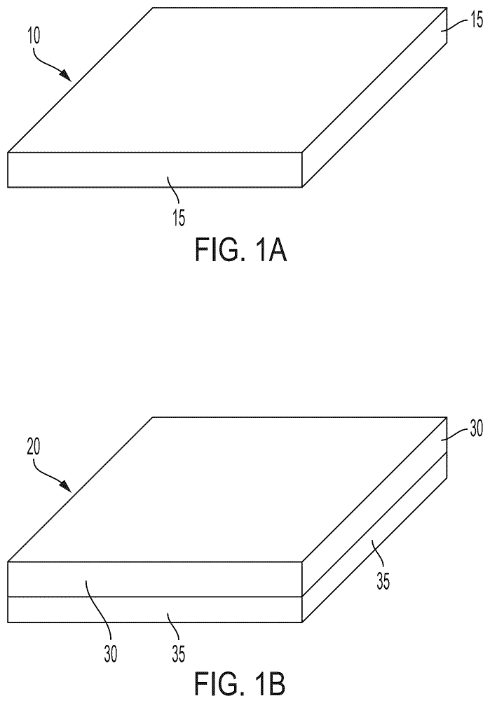

Compacts that ideally include a supportive cemented WC substrate are known in the metallurgy art as supported compacts. The manufacturing process can also alternatively be made without the presence of a supportive cemented WC substrate, in which case, the recovered compact is known in the metallurgy art as an unsupported compact. FIGS. 1A and 1B, respectively, demonstrate exemplary geometries of an unsupported compact 10 and a supported compact 20. The supported compact 20 shown in FIG. 1B typically includes a body 30 composed of sintered cBN particles, which is supported on a cemented WC substrate 35, and which body 30 is further anchored in a matrix of a ceramic binder material coupled byway of a transitioning interface. Optionally, they can be produced as freestanding/unsupported PCBN materials. The Co in the ceramic binder reacts with the WC being present in the added mill debris having at least therein WC, and the boron in the body 30, thus forming at least one discrete tough Co(x)W(y)B(z) phase during an HPHT sintering consolidation operation further described hereinafter in paragraphs ¶ [0079]-[0080]. In one example, (x) is 1, (y) is 2 and (z) is 2, and the at least one Co(x)W(y)B(z) tough phase includes CoW₂B₂. In another example, (x) is 1, (y) is 1 and (z) is 1, and the at least one Co(x)W(y)B(z) tough phase includes CoWB. Further formed individual phases within the ceramic binder are at least an AlN phase and an Al₂O₃ phase. An amount of aluminum may range from about 3 wt. % to about 6 wt. %, an amount of cobalt may range from about 0.9 wt. % to about 2.5 wt. %, and an amount of tungsten may range from about 5 wt. % to about 8 wt. % based on a total weight of the PcBN compact. The unsupported compact 10 shown in FIG. 1A equally includes a body 15 including sintered cBN particles. In both the unsupported compact 10 depicted in FIG. 1A and the supported compact 20 portrayed in FIG. 1B, the sintered body 15, 30 is composed of a plurality of wear resistant cBN particles compacted and bonded together. Each of the plurality of cBN particles contains a plurality of sub-grains. Each sub-grain may generally exhibit a size ranging from less than about 1 micron to about 2 microns, alternatively from about 0.1 micron to about 1.5 microns, as typically measured by a MicroTrac particle characterization system. A typical exemplary discrete cBN particle with a particle diameter of about 1 micron to about 2 microns may for instance contain from about 10 to about 5000 sub-grains.

### Methods of Manufacturing Sintered Polycrystalline Cubic Boron Nitride (PcBN) Compacts

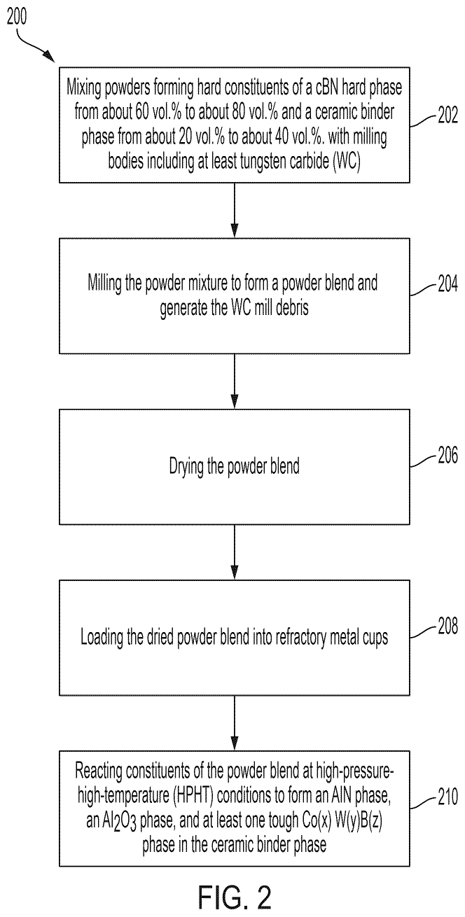

Turning now the attention to FIG. 2, this figure shows a flow diagram 200 depicting the individual process steps of manufacturing a PcBN compact for use in a tool in accordance with an exemplary embodiment of the subject matter.

The exemplary process 200 for example includes mixing powders forming hard constituents of (i) a cBN hard phase from about 60 vol. % to about 80 vol. % based on a total volume of the powder mixture and (ii) a ceramic binder phase from about 20 vol. % to about 40 vol. % based on the total volume of the formed powder mixture, with milling bodies including therein at least tungsten carbide (WC) in step 202.

A desired particle size of the cBN powder and the ceramic binder powder can be produced by subjecting the powder mixture to a milling treatment generally for several hours (e.g. 8, 16, 32, 64 hours) at typically ambient conditions (i.e. 25° C., 298.15 K and a pressure of 101.325 kPa in for example a ball mill, an attritor mill, or a planetary mill) with metallic binder(s) in the ceramic binder to form a powder blend and generate mill debris having therein at least WC in step 204. The general purpose of the blending by the milling operation is to facilitate a good ceramic binder distribution, and a good wettability between the components of the cBN and the ceramic binder powder mixture, thereby forming the powder blend. In some instances, the cBN powder and the ceramic binder powder can be crushed, or otherwise comminuted prior to milling with the metallic binder(s).

As would be apparent to a skilled artisan, the milling in step 204 is made by first adding a milling liquid to the cBN and the ceramic binder powders to form a milling slurry. The milling liquid may be water, an alcohol such as but not limited to ethanol, methanol, isopropanol, butanol, cyclohexanol, an organic solvent in the likes of for example hexane, heptane, acetone, toluene, or water, an alcohol mixture, an alcohol and a solvent mixture, or any combination thereof.

The process 200 can include a drying operation in step 206. The milled powder blend can be dried using any conventional techniques such as for example, vacuum drying, air drying, freeze drying, or spray drying to substantially remove by evaporating the solvent in the milled slurry.

The process 200 may optionally also include loading the dried powder blend into refractory metal cups in step 208.

Next, the process 200 may include an HPHT sintering consolidation operation in step 210. The refractory metal cups containing the dried powder blend can be placed in an HPHT-cell, and HPHT sintering conditions can be applied to form the sintered PcBN compact for use in a tool disclosed herein. Step 210 can include sintering at pressures spanning from about 4 gigapascal (GPa) to about 8 GPa, from about 5 GPa to about 8 GPa, from about 6 GPa to about 8 GPa, from about 7 GPa to about 8 GPa, from about 5 GPa to about 6 GPa, from about 5 GPa to about 7 GPa, or from about 6 GPa to about 7 GPa, and at temperatures ranging from about 1100° C. to about 1500° C., from about 1100° C. to about 1600° C., from about 1100° C. to about 1700° C., from about 1100° C. to about 1800° C., from about 1200° C. to about 1500° C., from about 1200° C. to about 1600° C., from about 1200° C. to about 1700° C., from about 1200° C. to about 1800° C., from about 1300° C. to about 1400° C., from about 1300° C. to about 1500° C., from about 1300° C. to about 1600° C., from about 1300° C. to about 1700° C., from about 1300° C. to about 1800° C., from about 1400° C. to about 1500°, from about 1400° C. to about 1600° C., from about 1500° C. to about 1600° C., from about 1500° C. to about 1700° C., from about 1500° C. to about 1800° C., from about 1600° C. to about 1800° C., or from about 1700° C. to about 1800° C.

The particular sintering pressure and temperature ranges are chosen, in a manner, that will result in a sufficient melting of the ceramic binder phase. The sintered PcBN compact may contain cBN grains that are uniformly, or that are substantially uniformly dispersed in the ceramic binder phase. During the HPHT sintering consolidation process, the Co in the ceramic binder reacts with the WC particles obtained from the mill debris as previously described in paragraph ¶ [0046] and the boron in the body 30, thereby forming at least one discrete tough Co(x)W(y)B(z) phase. In one example, (x) is 1, (y) is 2 and (z) is 2, and the at least one Co(x)W(y)B(z) tough phase includes CoW₂B₂. In another example, (x) is 1, (y) is 1 and (z) is 1, and the at least one Co(x)W(y)B(z) tough phase includes CoWB. Further formed individual phases within the ceramic binder are at least an AlN phase and an Al₂O₃ phase.

A skilled artisan would in practice readily know how an HPHT sintering consolidation procedure to form cBN is commonly performed. Thus, the reader is directed to for example U.S. Pat. No. 5,512,235B2; U.S. Pat. No. 10,196,314B2 and U.S. Pat. No. 10,252,947B2, to further gain insight into various HPHT sintering procedures, techniques, and methodologies, all of which documents, are incorporated herein by reference in their entirety.

After the HPHT sintering consolidation operation is complete in step 210, the resulting PcBN compact may be machined to form a disc of the PcBN compact. Machining may be performed via processes generally known in the art to form suitable cutting tools. Here, machining may suitably include electrical discharge machining (EDM), electrical discharge grinding (EDG), or other processes forming the PcBN compact into a desired shape. A suitable shape may for example include an 80° to a 120° triangle, thereby advantageously forming a tip to be used in various cutting, and machining applications after brazing the disc onto carbide tool bodies.

The compact that is formed by employing the PcBN composition described herein may advantageously be used to manufacture cutting tools. In some embodiments, the PcBN compact manufactured using the PcBN composition may be used to form cutting insert blanks for generally machining of metals and metal alloys. Thus, the PcBN compact formed according to the process 200 can be used for machining for instance difficult-to-cut metals, or metal alloys. For example, in such scenarios, the PcBN compact formed according to process 200 can be formed into cutting tools for machining high-strength alloys. In other embodiments, the PcBN compact may be used to manufacture interrupted cutting tooling, such as for example veined end mills, and/or milling inserts.

In sum, the formed PcBN compact employing the PcBN compositions herein may impart an enhanced abrasion resistance, and a stellar wear resistance, thereby significantly improving the cutting and machining properties, and thus ultimately leading to gained valuable increased lifetimes for such manufactured cutting tools.

### EXAMPLES

The following examples are put forth so as to provide those of ordinary skill in the art with a complete disclosure and description of how to make and use the described subject matter and are not intended to limit the scope of what the inventors regard as their disclosure nor are they intended to represent that the experiments below are all or the only experiments performed. Efforts have been made to ensure accuracy with respect to numbers used but some experimental errors and deviations should be accounted for.

### Example 1

### Identification of Phases by X-Ray Diffraction (XRD) Spectrum and Scanning Electron Microscope (SEM) Image Analysis of Sintered Polycrystalline Cubic Boron Nitride (PCBN)-Based Compact Materials

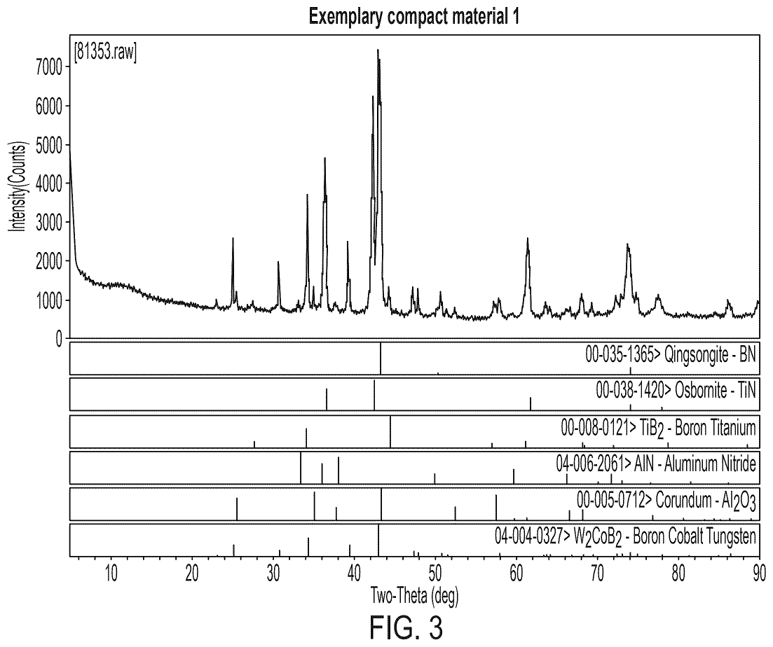

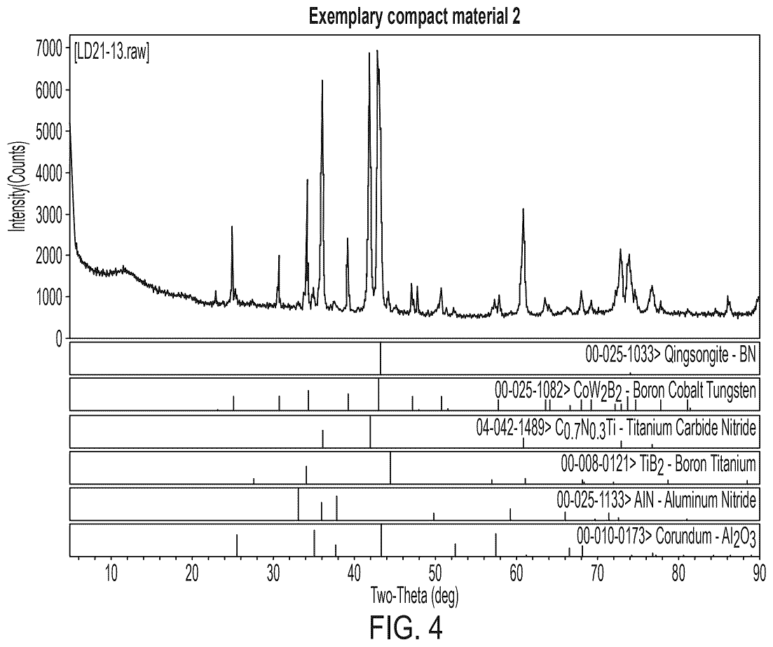

X-ray diffraction (XRD) spectrum was performed on sintered PcBN-based compact materials disclosed herein to identify the different phases being present in the PcBN-based compact materials. FIGS. 3 and 4 respectively show such exemplary XRD spectra with either a (i) TiN ceramic binder (Exemplary compact material 1), or a (ii) sub-stoichiometric (ss) TiCN ceramic binder (Exemplary compact material 2). These materials were manufactured according to standard methodological procedures for producing PcBN-based compacts. TiN and ss TiCN ceramic binder materials and cBN were mixed in ethanol to first form a milling slurry, which was next milled for at least 8 hours in order to ensure even distribution of the cBN, along with generating the desired level of cemented WC/Co mill debris in typically an attritor mill. Additional cobalt was added in an amount sufficient to ensure the formation of the desired Co(x)W(y)B(z) phases in the final PcBN-based compact. The resulting milling slurry was thereafter dried by vacuum drying, air drying, freeze drying, or spray drying. The resulting dried PcBN material supported on a cemented carbide substrate was further processed through subjecting the PcBN material to a high pressure high temperature (HPHT) operation by applying HPHT reaction parameters described in paragraph ¶ [0079]. The resulting sintered PcBN compacts were ground to size, cut to a suitable shape of for example an 80° to a 120° triangle, brazed onto carbide tool bodies, and finally formed into cutting tools.

The XRD spectra of FIGS. 3 and 4 verify that exemplary compact material 1 and Exemplary compact material 2 contain cBN, TiN or ss TiCN ceramic binder phases. The Co(x)W(y)B(z) phase is identified as being present as crystalline CoW₂B₂. As seen in FIGS. 3 and 4, the cBN phase is identified as the peak appearing at about 7000 intensity counts on the y-axis and about 43° on the x-axis (00-035-1365 in FIG. 3 and 00-025-1033 in FIG. 4). In FIG. 3, the TiN phase is represented by the peaks appearing at about 1000, 2500, 4500 and 6000 intensity-counts on the y-axis and about 36°, 42°, 62°, 73° and 77° on the x-axis (00-038-1420 in FIG. 3). In FIG. 4, the ss TiC_{0.7}N_{0.3} phase is represented by the peaks identified at about 1000, 2000, 3000, 6000 and 6800 intensity-counts on the y-axis and about 36°, 42°, 62°, 73° and 77° on the x-axis (00-042-1489 in FIG. 4). The CoW₂B₂ phase is observed having multiple peaks in FIGS. 3 and 4 (04-004-0327 in FIG. 3 and 00-025-1082 in FIG. 4). Finally, further identified phases in the analysis of the XRD spectra include at least titanium boride (TiB₂, 00-008-0121 in FIG. 3 and 00-008-0121 in FIG. 4), aluminum nitride (AlN, 04-006-2061 in FIG. 3 and 00-025-1133 in FIG. 4), and aluminum oxide (Al₂O₃, 00-005-0712 in FIG. 3 and 00-010-0173 in FIG. 4).

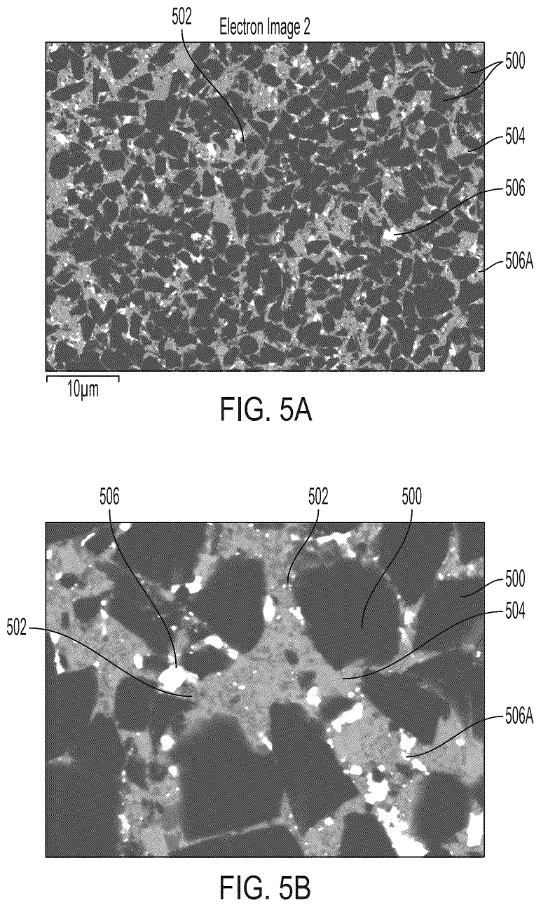

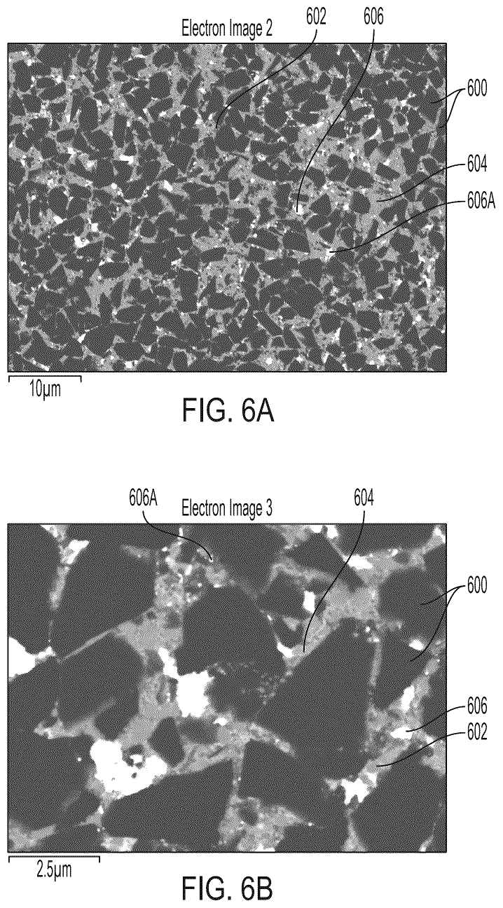

Scanning electron microscope (SEM) images were also prepared of the sintered PcBN-based compacts disclosed herein to identify the constituents of the compacts. FIGS. 5A and 5B are scanning electron microscope (SEM) images of a microstructure of an exemplary PcBN-based sintered compact including a titanium nitride (TiN) ceramic binder shown at a 2000× and 10000× magnification respectively. Likewise, FIGS. 6A and 6B are scanning electron microscope (SEM) images of a microstructure of an exemplary PcBN-based sintered compact including a ss titanium carbonitride (TiCN) ceramic binder equally depicted at a 2000× and 10000× magnification respectively. In the SEM images, cBN grains are identified as the dark areas reflected by numeral 500 in FIGS. 5A and 5B, and by numeral 600 in FIGS. 6A and 6B. Aluminum being a relatively light metal is identified as relatively dark grey areas reflected by numeral 502 in FIGS. 5A and 5B, and by numeral 602 in FIGS. 6A and 6B. Titanium-containing areas are identified as brighter grey areas reflected by numeral 504 in FIGS. 5A and 5B, and by numeral 604 in FIGS. 6A and 6B. Finally, Co and W both appear as bright white areas reflected by respectively numerals 506A and 506 in FIGS. 5A and 5B, and respectively by numerals 606A and 606 in FIGS. 6A and 6B.

### Example 2

Cutting of Case-Hardened 8620 Steel with Sintered Polycrystalline Cubic Boron Nitride (PCBN)-Based Compact Materials

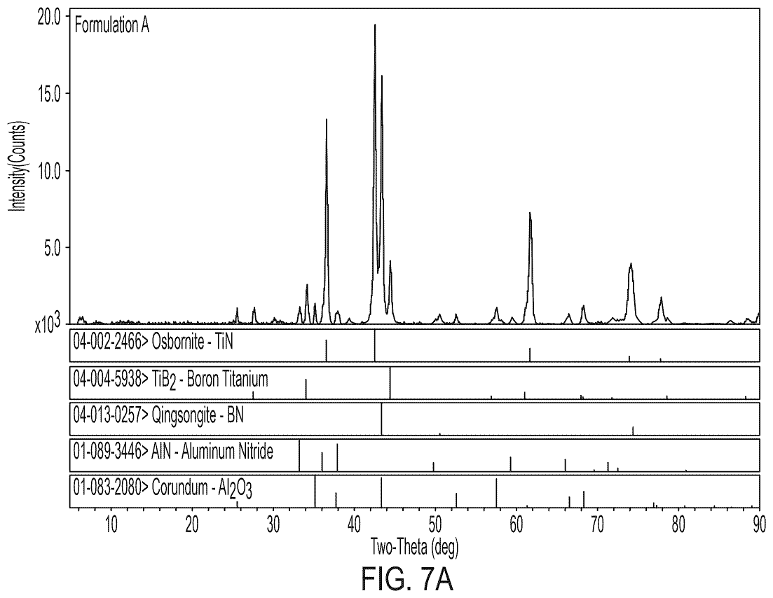

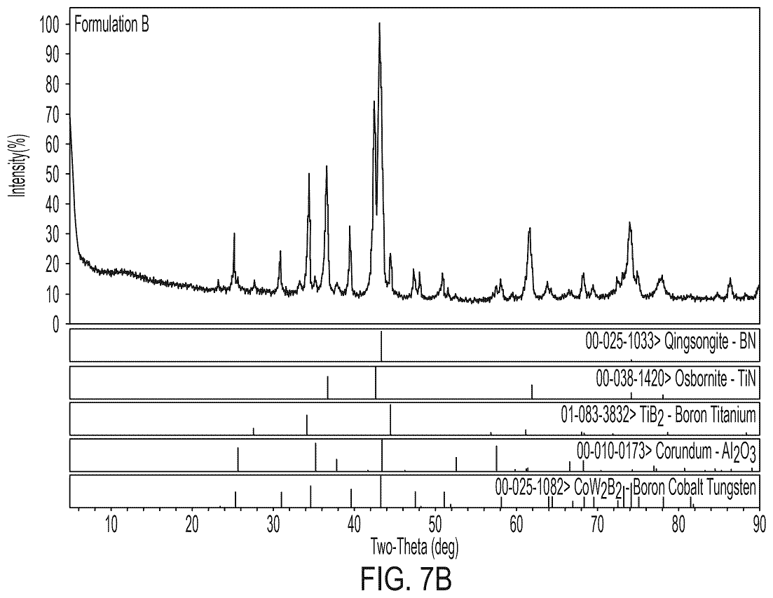

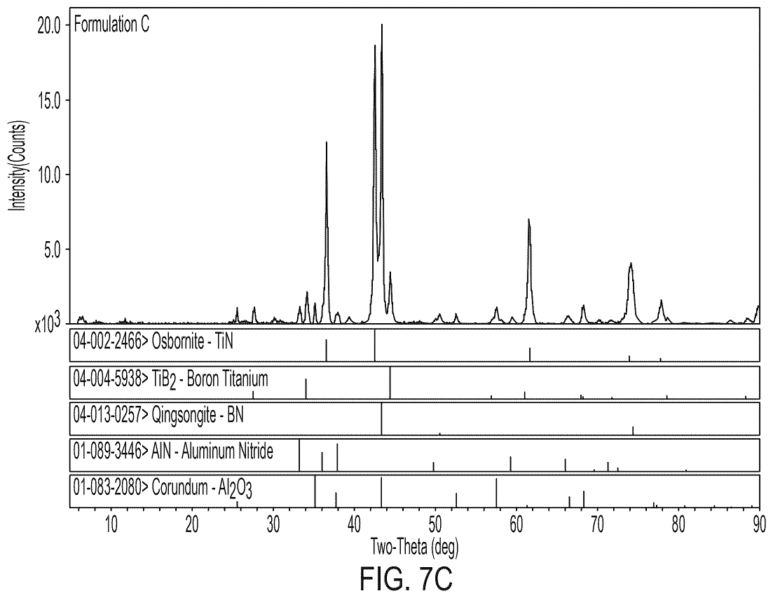

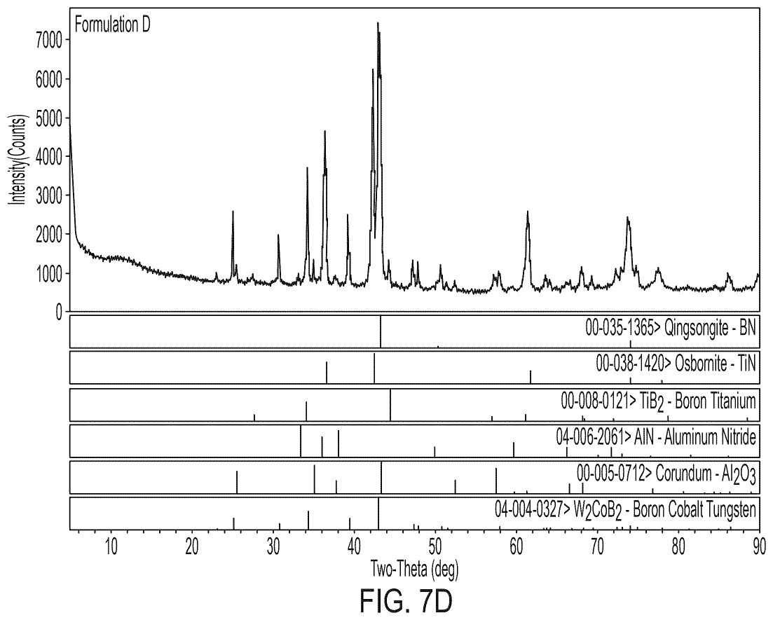

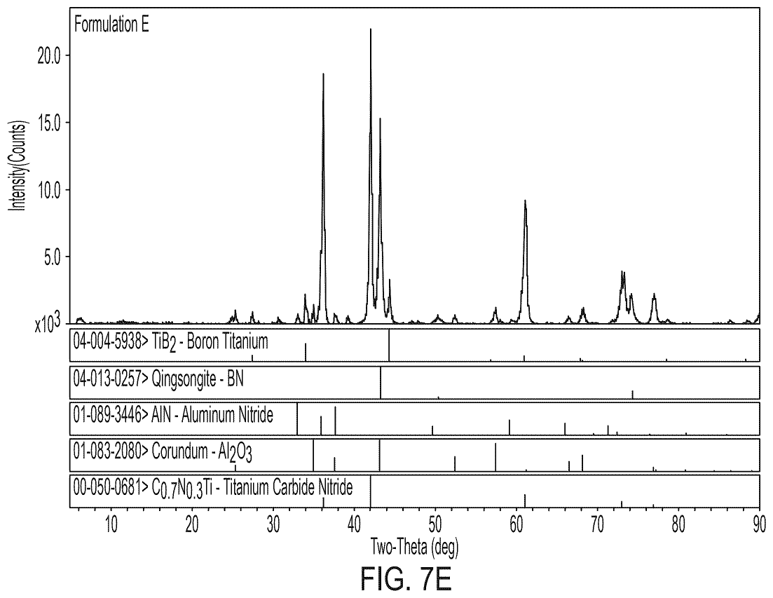

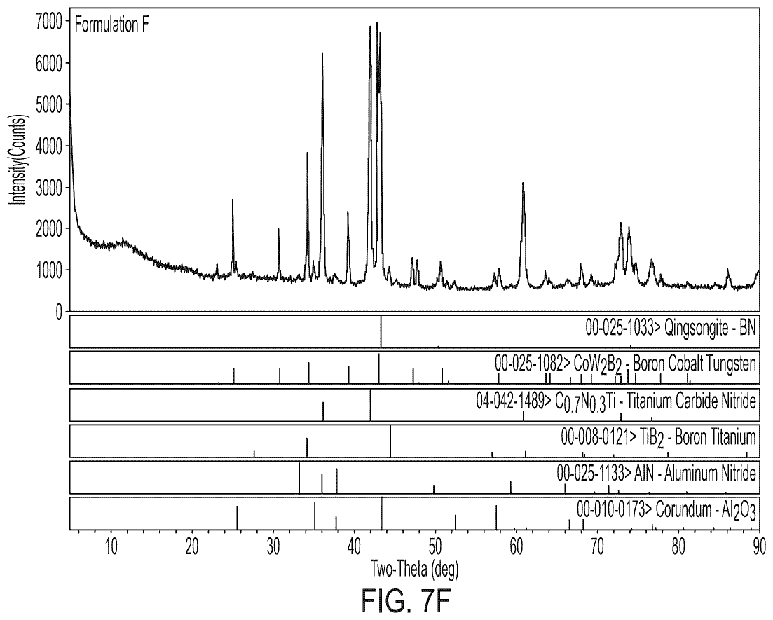

Work pieces composed of case-hardened 8620 steel was cut with PcBN-based compact materials manufactured as described previously in paragraph ¶ [0087], (i) a conventional grade (*) in Table 1 including at least about 65 vol. % based on a total volume of the PcBN composition, about 22 vol. %-23 vol. % TiN based on a total volume of the PcBN composition, 5 wt. % Al, 2.6 wt. % W, and 0.15 wt. % Co based on a total weight of the PcBN composition, as determined by energy dispersive spectroscopy (EDS) analysis (Formulation A shown with an asterisk (*) in Table 1 with an XRD spectrum shown in FIG. 7A), compared to (ii) an inventive grade including at least about 65 vol. % based on a total volume of the PcBN composition, about 21 vol. %-22 vol. % TiN based on a total volume of the PcBN composition, 5 wt. % Al, 6.4 wt. % W, and 1.4 wt. % Co, based on a total weight of the PcBN composition as determined by EDS analysis (Formulation B in Table 1 with an XRD spectrum shown in FIG. 7B).

Both the (i) conventional grade shown with an asterisk (*) in Table 1 and the (ii) inventive grade displayed a cBN grain size in a range of from about 2 microns to about 4 microns. The feed rate of the case-hardened 8620 steel was 0.2 mm/rev, the depth of the cut of the case-hardened 8620 steel was 0.15 mm, and the cutting speed of the case-hardened 8620 steel was 200 m/minute. The obtained results were the following. In mild interruption, the conventional grade failed due to fracture in an average of 0.39 linear km of cutting. On the other hand, the inventive grade was superior, and failed due to fracture in an average of 0.44 linear km of cutting. In severe interruption, the conventional grade failed due to fracture in an average of 0.34 linear km. In contrast, once again the inventive grade performed better, and failed due to fracture in an average of 0.41 linear km.

Additional formulations were tested, e.g. conventional grade C (Formulation C) shown with an asterisk (*) having a TiN binder with an XRD spectrum shown in FIG. 7C and conventional grade E (Formulation E) equally shown with an asterisk (*) having a TiCN binder with an XRD spectrum shown in FIG. 7E, respectively each compared to inventive grades D (Formulation D) and F (Formulation F) with XRD spectra shown in FIGS. 7D and 7F as depicted in Table 1.

As demonstrated in Table 1, the obtained trend was generally that the inventive material showed greater tool-life in the heavy interruption test when compared to its respective conventional composition.

In conclusion, the obtained data demonstrate that the inventive grade clearly outperforms the conventional grade.

TABLE 1

| | | | | | | | Mild | Heavy | | |
|---|---|---|---|---|---|---|---|---|---|---|
| | | cBN | | | | | Interruption | Interruption | | |
| | cBN | Grain | | Al | Co | W | Distance | Distance | | |
| Formulation | Vol. % | Size | Binder | Wt. % | Wt. % | Wt. % | (km) | (km) | | |
| A (*) | 65% | 2-4 μm | TiN | 5 | 0.15 | 2.6 | 0.39 | 0.34 | {close oversize brace} | Compared |
| B | 65% | 2-4 μm | TiN | 5 | 1.4 | 6.4 | 0.44 | 0.41 | | |
| C (*) | 70% | 2-4 μm | TiN | 3.8 | 0.2 | 2.6 | 0.27 | 0.43 | {close oversize brace} | Compared |
| D | 72% | 3-6 μm | TiN | 4.1 | 1.1 | 5.2 | 0.26 | 0.56 | | |
| E (*) | 62% | 2-4 μm | TiCN | 4.4 | 0.2 | 2.7 | 0.32 | 0.31 | {close oversize brace} | Compared |
| F | 70% | 3-6 μm | TiCN | 3.3 | 1.1 | 5.1 | 0.31 | 0.52 | | |

Although the present disclosure has been described in connection with embodiments thereof, it will be appreciated by those skilled in the art that additions, deletions, modifications, and substitutions not specifically described may be made without departure from the spirit and scope of the disclosure as defined in the appended claims.

With respect to the use of substantially any plural and/or singular terms herein, those having skill in the art can translate from the plural to the singular and/or from the singular to the plural as is appropriate to the context and/or application. The various singular/plural permutations are not expressly set forth herein for sake of clarity.

The herein described subject matter sometimes illustrates different components contained within, or connected with, different other components. It is to be understood that such depicted architectures are merely exemplary, and that in fact many other architectures may be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled,” to each other to achieve the desired functionality, and any two components capable of being so associated can also be viewed as being “operably couplable,” to each other to achieve the desired functionality. Specific examples of operably couplable include but are not limited to physically mateable and/or physically interacting components, and/or wirelessly interactable, and/or wirelessly interacting components, and/or logically interacting, and/or logically interactable components.

In some instances, one or more components may be referred to herein as “configured to,” “configured by,” “configurable to,” “operable/operative to,” “adapted/adaptable,” “able to,” “conformable/conformed to,” etc. Those skilled in the art will recognize that such terms (e.g., “configured to”) can generally encompass active-state components and/or inactive-state components and/or standby-state components, unless context requires otherwise.

While particular aspects of the present subject matter described herein have been shown and described, it will be apparent to those skilled in the art that, based upon the teachings herein, changes and modifications may be made without departing from the subject matter described herein and its broader aspects and, therefore, the appended claims are to encompass within their scope all such changes and modifications as are within the true spirit and scope of the subject matter described herein. It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.).

It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to claims containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations.

In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations).

Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that typically a disjunctive word and/or phrase presenting two or more alternative terms, whether in the description, claims, or drawings, should be understood to contemplate the possibilities of including one of the terms, either of the terms, or both terms unless context dictates otherwise. For example, the phrase “A or B” will be typically understood to include the possibilities of “A” or “B” or “A and B.”

With respect to the appended claims, those skilled in the art will appreciate that recited operations therein may generally be performed in any order. Also, although various operational flows are presented in a sequence(s), it should be understood that the various operations may be performed in other orders than those which are illustrated or may be performed concurrently. Examples of such alternate orderings may include overlapping, interleaved, interrupted, reordered, incremental, preparatory, supplemental, simultaneous, reverse, or other variant orderings, unless context dictates otherwise. Furthermore, terms like “responsive to,” “related to,” or other past-tense adjectives are generally not intended to exclude such variants, unless context dictates otherwise.

Those skilled in the art will appreciate that the foregoing specific exemplary processes and/or devices and/or technologies are representative of more general processes and/or devices and/or technologies taught elsewhere herein, such as in the claims filed herewith and/or elsewhere in the present application.

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

The illustrative embodiments described in the detailed description, drawings, and claims are not meant to be limiting. Other embodiments may be utilized, and other changes may be made, without departing from the spirit or scope of the subject matter presented here.

Where a range of values is provided, it is understood that each intervening value, to the tenth of the unit of the lower limit unless the context clearly dictates otherwise, between the upper and lower limit of that range and any other stated or intervening value in that stated range is encompassed within the disclosure. The upper and lower limits of these smaller ranges which can independently be included in the smaller ranges is also encompassed within the disclosure, subject to any specifically excluded limit in the stated range. Where the stated range includes one or both of the limits ranges excluding either both of those included limits are also included in the disclosure.

One skilled in the art will recognize that the herein described components (e.g., operations), devices, objects, and the discussion accompanying them are used as examples for the sake of conceptual clarity and that various configuration modifications are contemplated. Consequently, as used herein, the specific exemplars set forth and the accompanying discussion are intended to be representative of their more general classes. In general, use of any specific exemplar is intended to be representative of its class, and the non-inclusion of specific components (e.g., operations), devices, and objects should not be taken as limiting.

Additionally, for example any sequence(s) and/or temporal order of sequence of the system and method that are described herein this disclosure are illustrative and should not be interpreted as being restrictive in nature. Accordingly, it should be understood that the process steps may be shown and described as being in a sequence or temporal order, but they are not necessarily limited to being carried out in any particular sequence or order. For example, the steps in such processes or methods generally may be carried out in various different sequences and orders, while still failing within the scope of the present disclosure.

Finally, the discussed application publications and/or patents herein are provided solely for their disclosure prior to the filing date of the described disclosure. Nothing herein should be construed as an admission that the described disclosure is not entitled to antedate such publication by virtue of prior disclosure.

1. A polycrystalline cubic boron nitride (PcBN) composition, comprising:
a hard phase comprising cBN grains, the hard phase being present in an amount of from about 60 vol. % to about 80 vol. % based on total volume of the PcBN composition; and
a ceramic binder phase comprising an AlN phase, an Al₂O₃ phase, and at least one tough Co(x)W(y)B(z) phase, the ceramic binder phase being present in an amount of from about 20 vol. % to about 40 vol. % based on the total volume of the PcBN composition.

2. The PcBN composition of claim 1, wherein the ceramic binder phase further comprises sub-stoichiometric (ss) titanium nitride (TiN), titanium carbonitride (TiCN), or a combination thereof.

3. The PcBN composition of claim 1, wherein the ceramic binder phase further comprises substoichiometric or stoichiometric TiNO, TiCNO, or a combination thereof.

4. The PcBN composition of claim 1, wherein the cBN grains have a grain size in a range of from about 3 microns to about 6 microns.

5. (canceled)

6. The PcBN composition of claim 1, wherein cobalt G grains have a grain size in a range of from about 0.1 micron to about 1 micron.

7. The PcBN composition of claim 1, wherein tungsten carbide (WC) grains have a grain size in a range of from about 0.1 micron to about 1 micron.

8. The PcBN composition of claim 1, wherein (x) is 1, (y) is 2 and (z) is 2, and the at least one Co(x)W(y)B(z) tough phase comprises CoW₂B₂.

9. The PcBN composition of claim 1, wherein (x) is 1, (y) is 1 and (z) is 1, and the at least one Co(x)W(y)B(z) tough phase comprises CoWB.

10. The PcBN composition of claim 1, wherein aluminum is present in an amount of from about 3 wt. % to about 6 wt. %, cobalt is present in an amount of from about 0.9 wt. % to about 2.5 wt. %, and tungsten is present in an amount of from about 5 wt. % to about 8 wt. % based on total weight of the PcBN composition.

11. A method of manufacturing a sintered polycrystalline cubic boron nitride (PcBN) compact, comprising:
milling a powder mixture comprising powders forming hard constituents of a hard phase comprising cBN grains present in an amount of from about 60 vol. % to about 80 vol. % based on total volume of the powder mixture and a ceramic binder phase present in an amount from about 20 vol. % to about 40 vol. % based on the total volume of the powder mixture, with milling bodies comprising at least tungsten carbide (WC) and cobalt to form a powder blend and generate mill debris;
drying the powder blend and the mill debris; and
sintering the powder blend and the mill debris at high-pressure-high-temperature (HPHT) conditions to form an AlN phase, an Al₂O₃ phase, and at least one tough Co(x)W(y)B(z) phase in the ceramic binder phase.

12. The method of manufacturing a sintered PcBN compact of claim 11, wherein the ceramic binder phase further comprises sub-stoichiometric (ss) titanium nitride (TiN), titanium carbonitride (TiCN), or a combination thereof.

13. The method of manufacturing a sintered PcBN compact of claim 11, wherein the ceramic binder phase further comprises substoichiometric or stoichiometric TiNO, TiCNO, or a combination thereof.

14.-17. (canceled)

18. The method of manufacturing a sintered PcBN compact of claim 11, wherein the drying the powder blend comprises vacuum drying, air drying, freeze drying, or spray drying.

19. The method of manufacturing a sintered PcBN compact of claim 11, wherein the milling is performed with one or more solvents comprising ethanol, methanol, isopropanol, butanol, cyclohexanol, acetone, hexane, heptane, toluene, water, or any combination thereof as a milling slurry of the powder blend.

20. The method of manufacturing a sintered PcBN compact of claim 11, wherein the HPHT conditions comprise pressures in a range of from about 4 gigapascal (GPa) to about 8 GPa and temperatures in a range of from about 1100° C. to about 1800° C.

21. The method of manufacturing a sintered PcBN compact of claim 11, wherein (x) is 1, (y) is 2 and (z) is 2, and the at least one Co(x)W(y)B(z) tough phase comprises CoW₂B₂.

22. The method of manufacturing a sintered PcBN compact of claim 11, wherein (x) is 1, (y) is 1 and (z) is 1, and the at least one Co(x)W(y)B(z) tough phase comprises CoWB.

23. The method of manufacturing a sintered PcBN compact of claim 11, wherein aluminum is present in an amount of from about 3 wt. % to about 6 wt. %, cobalt is present in an amount of from about 0.9 wt. % to about 2.5 wt. %, and tungsten is present in an amount of from about 5 wt. % to about 8 wt. % based on total weight of the PcBN compact.

24. The method of manufacturing a sintered PcBN compact of claim 11, further comprising loading the powder blend into refractory metal cups after drying the powder blend.

25. A cutting tool, comprising the PcBN composition of claim 1.

26. (canceled)
